(19) United States
(12) Patent Application Publication
(10) Pub. No.: US 2020/0056857 A1
(43) Pub. Date: Feb. 20, 2020

(54) Shooting rest

(71) Applicant: John Douglas Stubbs, Victoria, TX (US)

(72) Inventor: John Douglas Stubbs, Victoria, TX (US)

(21) Appl. No.: 16/501,912

(22) Filed: Jul. 3, 2019

Related U.S. Application Data
(60) Provisional application No. 62/765,146, filed on Aug. 17, 2018.

(51) Int. Cl. F41A 23/16; F16M 13/02

(52) U.S. Cl. CPC F41A 23/16; F16M 13/022

(57) ABSTRACT

A shooting rest and method for shooting a rifle or shotgun or crossbow from inside a hunting blind, the hunting blind having an open window in a wall of the hunting blind, the open window having a lower edge. The rest includes a bracket; a beam having a longitudinal axis; and a telescoping length support, the bracket for demountable engagement on the lower edge of the open window of the blind, the beam having a first end and a second end, the first end of the beam attached to the bracket, the telescoping length support having a first end and a second end, the first end of the telescoping length support attached to the beam, the length of the telescoping length support being adjusted so that the telescoping length support angles from the beam to the wall of the blind below the open window so that the second end of the telescoping length support contacts said wall so that the longitudinal axis of the beam can be adjusted to be level with the earth or at an angle thereto.

### BACKGROUND OF THE INVENTION

The instant invention relates to shooting rests for shooting a rifle or shotgun or crossbow from inside a hunting blind. A number of shooting rests for shooting a rifle or shotgun or crossbow from inside a hunting blind have been discovered that cradle the rifle or shotgun or crossbow as disclosed, for example, in U.S. Pat. Nos. 5,778,589; 5,964,435; 9,200,858; 9,625,229 and US Patent Application Publication 2006/0254114. Such shooting rests are well adapted for target shooting but do not permit ready vertical adjustment of sighting a rifle or shotgun or crossbow. The shooting rest disclosed in US Patent Application Publication 2018/0010875 provides a vertically adjustable horizontal support bolted to the wall of a hunting blind. It would be an advance in the art of shooting rests for shooting a rifle or shotgun or crossbow from inside a hunting blind if a rest were discovered that provided a support that could be adjusted to be level with the earth or at an angle thereto and which could be demountably attached to the window frame of a hunting blind.

### SUMMARY OF THE INVENTION

The instant invention is the discovery of a shooting rest for shooting a rifle or shotgun or crossbow from inside a hunting blind, which rest provides a support that can be adjusted to be level with the earth or at an angle thereto and which can be demountably attached to the window frame of a hunting blind. More specifically, the instant invention is a shooting rest for shooting a rifle or shotgun or crossbow from inside a hunting blind, the hunting blind comprising an open window in a wall of the hunting blind, the open window comprising a lower edge, comprising: a bracket; a beam having a longitudinal axis; and a telescoping length support, the bracket for demountable engagement on the lower edge of the open window of the blind, the beam having a first end and a second end, the first end of the beam attached to the bracket, the telescoping length support having a first end and a second end, the first end of the telescoping length support attached to the beam, the length of the telescoping length support being adjusted so that the telescoping length support angles from the beam to the wall of the blind below the open window so that the second end of the telescoping length support contacts said wall so that the longitudinal axis of the beam can be adjusted to be level with the earth or at an angle thereto. In another embodiment, the instant invention is a method for a hunter to shoot a rifle or shotgun or crossbow from inside a hunting blind, the hunting blind comprising an open window in a wall of the hunting blind, the open window comprising a lower edge, comprising: engaging the bracket of the rest of the instant invention to the lower edge of the open window, adjusting the length of the telescoping length support of the rest of the instant invention to level the longitudinal axis of the beam of the rest of the rest of the instant invention with the earth or at an angle thereto so that the hunter can hold a rifle or shotgun or crossbow with one hand of the hunter supporting the fore end of the rifle or shotgun or crossbow with the trigger finger hand of the hunter supporting the grip of the rifle or shotgun or crossbow with the butt of the rifle or shotgun or crossbow against the shoulder of the hunter so that the hunter can rest his/her trigger finger hand arm or elbow on the beam of the rest of the instant invention to steady his/her aim while permitting ready adjustment of the aim of the rifle or shotgun or crossbow in both the vertical and horizontal directions.

### BRIEF DESCRIPTION OF THE DRAWINGS

FIG. 1 is a side view of a highly preferred embodiment of the instant invention;

FIG. 2 is a perspective view of the embodiment of FIG. 1 installed in a hunting blind; and

FIG. 3 is a perspective view of a hunter supporting the fore end of an air rifle with his left hand, the right hand of the hunter supporting the grip of the air rifle with the butt of the air rifle against the shoulder of the hunter so that the hunter can rest his right arm or elbow on the beam of the rest to steady his aim while permitting ready adjustment of the aim of the air rifle in both the vertical and horizontal directions.

### DETAILED DESCRIPTION OF THE INVENTION

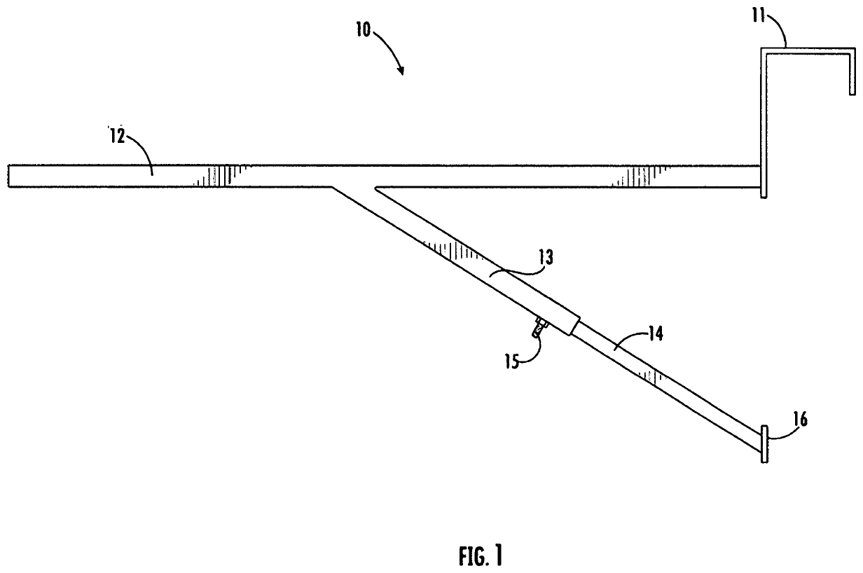

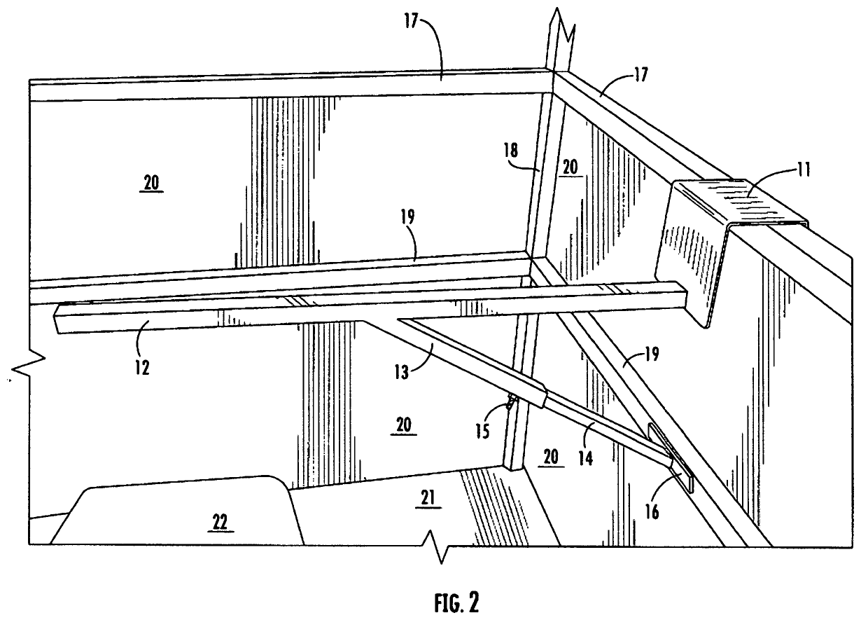

Referring now to FIGS. 1 and 2, therein is shown a highly preferred shooting rest 10 of the instant invention for shooting a rifle or shotgun or crossbow from inside a hunting blind, the hunting blind comprising an open window in wall 20 of the hunting blind, the open window comprising a lower edge 17. The hunting blind comprises frame vertical frame member 18, horizontal frame member 19, floor 21 and seat 22. Shooting rest 10 comprises: U or J shaped bracket 11 for demountable engagement on the lower edge 17 of the blind; beam 12 having a longitudinal axis; and a telescoping length support wherein first linear section 14 is partially inserted into second linear tubular section 13. Beam 12 has a first end and a second end. The first end of beam 12 is attached to bracket 11. The telescoping length support has a first end and a second end, the first end of telescoping length support (one end of tubular section 13) is attached to beam 12. The other end of telescoping length support (one end of first linear section 14) attached to plate 16. The bottom of tubular section 13 is slotted to engage with bolt 15, which bolt 15 is attached to first linear section 14 so that the length of the telescoping length support can be adjusted so that the telescoping length support angles from beam 12 to wall 20 or frame member 19 of the blind below the open window so that plate 16 of the telescoping length support contacts said wall 20 or frame member 19 so that the longitudinal axis of beam 12 can be adjusted to be level with the earth or at an angle thereto.

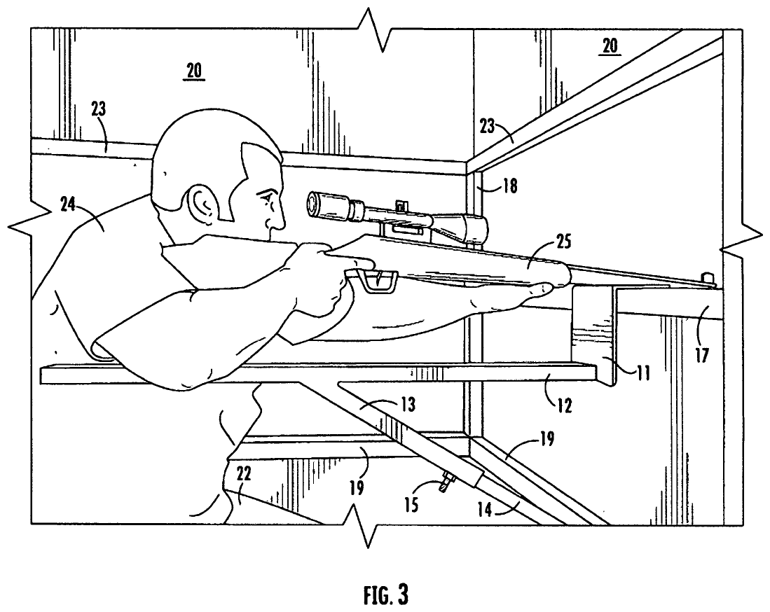

Referring to FIG. 3, therein is shown hunter 24 shooting air rifle 25 from inside a hunting blind. The hunting blind comprises an open window in wall 20 of the hunting blind. The hunting blind is comprised of frame members 18, 19 and 23. The open window comprises lower edge 17. Bracket 11 is engaged with the lower edge 17 of the open window. The length of the telescoping length support of the rest has been adjusted to level the longitudinal axis of beam 12 to be level with the earth or at an angle thereto as desired by hunter 24. Hunter 24 is shown holding the fore end of air rifle 25 with one hand with the trigger finger of the other hand of the hunter supporting the grip of air rifle 25 with the butt of air rifle 25 against the shoulder of hunter 25 so that hunter 25 can rest his trigger finger hand arm or elbow on beam 12 of the rest to steady his aim while permitting ready adjustment of the aim of air rifle 25 in both the vertical and horizontal directions.

The components of the instant invention can be made of any suitable material. The bracket is preferably formed from sheet steel. The beam is preferably square steel tubing. The adjustable length telescoping support preferably comprises square steel tubing sections. The length of the telescoping support can be fixed by the bolt as shown in FIGS. 1-3 or by a cam lock or by a collet or a pin or any other suitable means.

Since the bracket of the instant invention engages with and rests on the lower edge of the window of a hunting blind, the rest of the instant invention can be readily and quietly slid along the lower edge of the widow of the blind or moved to another window of the blind. The adjustable length support of the rest of the instant invention readily adapts the level of the beam as desired to a hunting blind of any type of construction having an open window in a wall of the blind. The level of the beam can be adjustable to be level with the earth for shooting from a ground blind or at an incline for shooting from an elevated blind. The shooting rest of the instant invention provides a combination of simplicity, versatility and effectiveness not provided by any prior art shooting rest.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains.

What is claimed is:

1. A shooting rest for shooting a rifle or shotgun or crossbow from inside a hunting blind, the hunting blind comprising an open window in a wall of the hunting blind, the open window comprising a lower edge, the shooting rest comprising: a bracket; a beam having a longitudinal axis; and a telescoping length support, the bracket for demountable engagement on the lower edge of the open window of the blind, the beam having a first end and a second end, the first end of the beam attached to the bracket, the telescoping length support having a first end and a second end, the first end of the telescoping length support attached to the beam, the length of the telescoping length support being adjusted so that the telescoping length support angles from the beam to the wall of the blind below the open window so that the second end of the telescoping length support contacts said wall so that the longitudinal axis of the beam can be adjusted to be level with the earth or at an angle thereto.

2. The shooting rest of claim 1, wherein the bracket is U or J shaped for demountable engagement on the lower edge of the open window of the blind.

3. The shooting rest of claim 1, wherein the telescoping length support comprises a first linear section partially inserted into a second linear tubular section.

4. The shooting rest of claim 2, wherein the telescoping length support comprises a first linear section partially inserted into a second linear tubular section.

5. A method for a hunter to shoot a rifle or shotgun or crossbow from inside a hunting blind, the hunting blind comprising an open window in a wall of the hunting blind, the open window comprising a lower edge, the method comprising: engaging the bracket of the rest of claim 1 to the lower edge of the open window, adjusting the length of the telescoping length support of the rest of claim 1 to level the longitudinal axis of the beam of the rest of claim 1 with the earth or at an angle thereto so that the hunter can hold a rifle or shotgun or crossbow with one hand of the hunter supporting the forefend of the rifle or shotgun with the trigger finger hand of the hunter supporting the grip of the rifle or shotgun or crossbow with the butt of the rifle or shotgun or crossbow against the shoulder of the hunter so that the hunter can rest his/her trigger finger hand arm or elbow on the beam of the rest of claim 1 to steady his/her aim while permitting ready adjustment of the aim of the rifle or shotgun or crossbow in both the vertical and horizontal directions.
